(19) United States
(12) Patent Application Publication
(10) Pub. No.: US 2026/0209472 A1
(43) Pub. Date: Jul. 23, 2026

(54) NON-FLUORINATED HYDROPHOBIC THERMOPLASTIC COMPOSITIONS CONTAINING FATTY ACID AMIDE AND ARTICLES FORMED THEREFROM

(71) Applicant: Avient Corporation, Avon Lake, OH (US)

(72) Inventors: Ryan Divens, Naples, FL (US); Jian Zhou, Avon, OH (US); Nicholas DeLucia, Mayfield Heights, OH (US); Nicholas Nun, Eastlake, OH (US)

(73) Assignee: Avient Corporation, Avon Lake, OH (US)

(21) Appl. No.: 19/140,649

(22) PCT Filed: Dec. 18, 2023
(86) PCT No.: PCT/US2023/084554

§ 371 Date: Jun. 18, 2025

Related U.S. Application Data
(60) Provisional application No. 63/433,572, filed on Dec. 19, 2022.

(51) Int. Cl. C08K 5/20; C08J 5/18; C08L 23/12

(52) U.S. Cl. CPC C08K 5/20; C08J 5/18; C08L 23/12; C08J 2323/12; C08L 2203/16

(57) ABSTRACT

Thermoplastic compositions comprise non-fluorinated hydrophobic additive comprising fatty acid amide, synergistic polymer additive comprising functional copolymer with pendant epoxide groups or alkylene oxide repeating units, and thermoplastic polymer. The combination of the non-fluorinated hydrophobic additive and the synergistic polymer additive results in thermoplastic compositions having improved hydrophobicity and/or enhanced durability of hydrophobicity while also being free of fluorine and fluorinated substances.

### CLAIM OF PRIORITY

This application claims priority from U.S. Provisional Patent Application Ser. No. 63/433,572 bearing Attorney Docket Number 1202223-US-F and filed on Dec. 19, 2022, which is hereby incorporated by reference in its entirety.

### TECHNICAL FIELD

The present disclosure relates to non-fluorinated hydrophobic thermoplastic compositions. More particularly, non-fluorinated hydrophobic thermoplastic compositions include non-fluorinated hydrophobic additive and synergistic polymer additive, providing improved hydrophobicity and/or enhanced durability of hydrophobicity of the thermoplastic compositions while also being free of fluorine and fluorinated substances.

### BACKGROUND

Thermoplastic articles having hydrophobic properties (i.e., water-repelling performance) are desirable for many end-use applications across a variety of industries. Conventionally, hydrophobic properties may be imparted to thermoplastic articles by using fluorinated surfactants as functional additives. More recently, however, demand is growing for non-fluorinated alternatives in view of environmental concerns with certain categories of fluorinated compounds like per- and polyfluoroalkyl substances (PFAS). However, conventional non-fluorinated alternatives may not provide the desired level of hydrophobicity and/or durability of hydrophobicity.

Accordingly, a need exists for non-fluorinated thermoplastic compositions having increased hydrophobicity and/or enhanced durability of hydrophobicity.

### SUMMARY

Embodiments of the present disclosure are directed to non-fluorinated hydrophobic thermoplastic compositions, articles formed from the thermoplastic compositions, and related systems and methods.

According to some embodiments, a thermoplastic composition is provided. The thermoplastic composition comprises: (a) non-fluorinated hydrophobic additive comprising fatty acid amide; (b) synergistic polymer additive comprising functional copolymer with pendant epoxide groups or alkylene oxide repeating units; and (c) thermoplastic polymer; wherein the thermoplastic composition is free of fluorine and fluorinated substances.

According to other embodiments, a thermoplastic article is provided. The thermoplastic article is formed from the thermoplastic composition as disclosed herein, wherein the thermoplastic article is free of fluorine and fluorinated substances.

According to further embodiments, a multilayer article is provided. The multilayer article comprises (a) an outer layer formed from the thermoplastic composition as disclosed herein; and (b) an inner layer formed from a material excluding the thermoplastic composition; wherein the multilayer article is free of fluorine and fluorinated substances.

According to even further embodiments, a system is provided. The system comprises (a) a component formed from the thermoplastic composition as disclosed herein, wherein the component is free of fluorine and fluorinated substances; and (b) an aqueous liquid in physical contact with at least a portion of the component.

According to other embodiments, a method of imparting hydrophobicity to a surface of a thermoplastic article is provided. The method comprises the step of forming the thermoplastic article from the thermoplastic composition as disclosed herein, wherein the thermoplastic article is free of fluorine and fluorinated substances.

Additional features and advantages of this and other embodiments will be set forth in the detailed description which follows, and in part will be readily apparent to those skilled in the art from the detailed description or recognized by practicing the embodiments described herein, including the detailed description and the claims, which follow.

### DETAILED DESCRIPTION

Reference is made hereinafter to various embodiments of non-fluorinated hydrophobic thermoplastic compositions, articles formed therefrom, and related systems and methods.

The disclosure should not be construed as limited to the embodiments set forth herein. Rather, these embodiments are provided so that this disclosure will be thorough and complete, and will fully convey the subject matter to those skilled in the art.

### Definitions

Unless otherwise expressly defined, all technical and scientific terms used herein have the same meaning as commonly understood by a person of ordinary skill in the art. The terminology used in the disclosure herein is for describing particular embodiments only and is not intended to be limiting.

Unless otherwise expressly stated, it not intended that any method disclosed herein be construed as requiring that its steps be performed in a specific order, nor that any article set forth herein be construed as requiring specific orders or orientations to its individual components.

Unless otherwise expressly stated, it is intended that any composition or mixture disclosed herein may comprise, consist essentially of, or consist of the disclosed components.

As used herein, the singular form of a term is intended to include the plural form of the term, unless the context clearly indicates otherwise.

As used herein, numerical values are not strictly limited to the exact numerical value recited. Instead, unless otherwise expressly stated, each numerical value is intended to mean both the exact numerical value and “about” the numerical value, which encompasses a functionally equivalent range surrounding that numerical value, such that either possibility is contemplated as an embodiment disclosed herein.

As used herein, the term “hydrophobicity” refers the tendency of a surface of a material (or an article formed from the material) to repel water (i.e., water-repelling performance).

As used herein, the term “ambient conditions” refers to a temperature of 23+/−2° C. and a relative humidity of 50+/−10%.

As used herein, the term “ambient aging” refers to aging of a material in an air-conditioned laboratory environment at ambient conditions (i.e., 23+/−2° C. and a relative humidity of 50+/−10%) for 240+/−2 hours according to ASTM D618.

As used herein, the term “heat aging” refers to aging of a material in an air-circulating oven that maintains air temperature of 75+/−2° C. and a relative humidity of between 2% and 6% for 120+/−2 hours. The air-circulating oven has a constant horizontal air draft that exchanges the air in the oven for minimum 5 times per hour. After the heat oven exposure, the material is then cooled in an air-conditioned lab environment with 23+/−2° C. and 50+/−10% relative humidity for at least 4 hours prior to testing.

As used herein, the term “durability of hydrophobicity” refers to a retention of hydrophobicity of a material after heat aging. It may be quantified by a difference in the hydrophobicity of the material after heat aging relative to the hydrophobicity of the material after ambient aging only. A smaller absolute difference indicates a better durability of hydrophobicity.

As used herein, the term “formed from” (including related terms such as “forming”) refers to, with respect to an article (or component of an article) and a thermoplastic material, that the article (or component of the article) is extruded, molded, shaped, pressed, or otherwise made, in whole or in part, from the thermoplastic material under sufficient heating to enable such forming. As such, the term “formed from” (including related terms such as “forming”) means, in some embodiments, the article (or component of an article) can comprise, consist essentially of, or consist of, the material; and, in other embodiments, the article (or component of an article) consists of the material because the article (or component of an article) is, for example, made by an extrusion process or a molding process.

As used herein, the terms “free of fluorine and fluorinated substances” and “non-fluorinated” refer to a component or a material or an article wherein, in embodiments, no amounts of fluorine and/or fluorinated substances are intentionally added; or, in embodiments, no amounts of fluorine and/or fluorinated substances are detectable using conventional means of detection; or, in embodiments, no amounts of fluorine and/or fluorinated substances are present.

As used here, the term “haze” refers to the percentage of light scattered as it passes through a material as measured according to ASTM D1003 at a specimen thickness of 0.8 mm.

As used herein, the term “masterbatch formulation” refers to a thermoplastic composition that is a concentrated mixture of one or more additives dispersed in a carrier and may be used by blending it at a certain rate or proportion (i.e., let-down) into typically a relatively higher proportion of a neat thermoplastic polymer base resin during a process of forming a final thermoplastic article in order to impart one or more desired properties to the final thermoplastic article. In the fields of thermoplastic compounding and thermoplastic article manufacturing, an additive masterbatch formulation may also be referred to as an additive concentrate formulation. In a masterbatch formulation, the carrier may be the same as or different from the thermoplastic polymer as described herein below for use in the thermoplastic composition as disclosed herein (i.e., the major thermoplastic polymer used for forming a final thermoplastic article). A suitable carrier may be solid or liquid. Non-limiting examples of a suitable carrier may include linear low-density polyethylene, polyethylene wax, polybutadiene, ethylene vinyl acetate copolymers, and ethylene methyl acrylate copolymers. The carrier may have a lower melt viscosity than that of the major thermoplastic polymer used for forming the final thermoplastic article in order to achieve a good dispersion of the functional additives present in the masterbatch formulation throughout the thermoplastic polymer matrix of the final thermoplastic article.

As used herein, the term “ready-for-forming formulation” refers to a thermoplastic composition that may be used as provided (i.e., without further blending with an additive masterbatch formulation or neat additives) to form a final thermoplastic article having one or more desired properties. In the fields of thermoplastic compounding and thermoplastic article manufacturing, a ready-for-forming formulation may also be referred to as a pre-compounded thermoplastic formulation, a thermoplastic molding or extrusion compound, or other names.

As used herein, the term “residual dye” refers to a value corresponding to the amount of dye remaining on the surfaces of a specimen material as determined according to the residual dye test. A lower residual dye value indicates a higher level of hydrophobicity.

As used herein, the term “residual dye test” refers to the procedures of the residual dye test as described in the Examples herein below, which includes the procedures for (a) conditioning of plaques, (b) preparing dye test solution and calibration curve between the absorbance and dye concentration, and (c) dipping and UV-VIS test procedure or gravimetric test procedure; each as described in the Examples.

As used herein, the term “transmittance” refers to the percentage of light that passes through a material as measured according to ASTM D1003 at a specimen thickness of 0.8 mm.

As used herein, the term “type I primary fatty acid amide” refers to a fatty acid amide having a structure of formula A wherein R′ is H and R is formula B; all as further described herein including under the “Non-Fluorinated Hydrophobic Additive” section herein below.

As used herein, the term “type II primary fatty acid amide” refers to a fatty acid amide having a structure of formula C; all as further described herein including under the “Non-Fluorinated Hydrophobic Additive” section herein below.

### Usefulness

As discussed hereinabove, thermoplastic articles having hydrophobic properties (i.e., water-repelling performance) are desirable for many end-use applications across a variety of industries. Conventionally, hydrophobic properties may be imparted to thermoplastic articles by using fluorinated surfactants as functional additives. More recently, however, there is growing demand for non-fluorinated alternatives in view of environmental concerns with certain categories of fluorinated compounds like per- and polyfluoroalkyl substances (PFAS).

Potential alternatives to fluorinated surfactants include fatty acid amide waxes. For example, when a fatty acid amide wax such as erucamide is used as an additive, it is possible to impart, at least initially, desirable hydrophobicity levels to thermoplastic articles. However, the hydrophobicity levels imparted by erucamide are not durable, especially when it is used at relatively lower loading levels. Indeed, upon heat aging, the hydrophobicity levels can severely deteriorate.

The thermoplastic compositions and articles as disclosed herein address the aforementioned problems. In particular, it has been found that thermoplastic compositions that include a combination of non-fluorinated hydrophobic additive comprising fatty acid amide and a synergistic polymer additive comprising a functional copolymer with pendant epoxide groups or alkylene oxide repeating units may have improved hydrophobicity and/or enhanced durability of hydrophobicity while also being free of fluorine and fluorinated substances.

Accordingly, the thermoplastic compositions as disclosed herein may be used to make any thermoplastic article that requires improved hydrophobicity and/or enhanced durability of hydrophobicity without the use of fluorinated compounds. The thermoplastic compositions as disclosed herein are especially useful for making thermoplastic articles for laboratory plasticware applications including but not limited to beakers, bottles, containers, dishes, flasks, funnels, jars, pipettes, pipette tips, tubes, vials, and the like; and medical and/or personal care and/or personal protection applications including but not limited to gowns, drapes, curtains, dressings, aprons, coverings, pads, and the like.

### Thermoplastic Composition

Thermoplastic compositions as disclosed herein comprise (a) non-fluorinated hydrophobic additive comprising fatty acid amide; (b) synergistic polymer additive comprising functional copolymer with pendant epoxide groups or alkylene oxide repeating units; and (c) thermoplastic polymer. The thermoplastic compositions are free of fluorine and fluorinated substances. The combination of the non-fluorinated hydrophobic additive and the synergistic polymer additive results in thermoplastic compositions having improved hydrophobicity and/or enhanced durability of hydrophobicity while also being free of fluorine and fluorinated substances.

In embodiments, as further described herein below, the hydrophobic additive may comprise at least one of a primary fatty acid amide and a secondary fatty acid amide.

In embodiments, as further described herein below, the synergistic polymer additive may comprise at least one of styrene-acrylic copolymer comprising pendant epoxide groups and ethylene-acrylic copolymer comprising pendant epoxide groups.

In embodiments, the thermoplastic composition may be a masterbatch formulation or a ready-for-forming formulation.

In embodiments in which the thermoplastic composition is a masterbatch formulation, loading levels of the different ingredients may vary based on factors including but not necessarily limited to intended let-down ratio, intended loading levels of the different ingredients in the ready-for-forming formulation, and target performance properties of thermoplastic articles formed from the ready-for-forming formulation.

For example, in embodiments, the masterbatch formulation may comprise, based on a total weight of the thermoplastic composition: (a) non-fluorinated hydrophobic additive in an amount from about 2.5 wt. % to about 25 wt. %; (b) synergistic polymer additive in an amount from about 2.5 wt. % to about 40 wt. %; (c) thermoplastic polymer carrier in an amount from about 20 wt. % to about 95 wt. %; optionally (d) secondary synergistic additive in an amount from 0 wt. % to about 10 wt. %; and optionally (e) other additives in an amount from 0 wt. % to about 5 wt. %.

In embodiments in which the thermoplastic composition is a ready-for-forming formulation, loading levels of the different ingredients may vary based on factors including target performance properties of a thermoplastic article formed from the ready-for-forming formulation and which type of the non-fluorinated hydrophobic additive is used.

For example, in embodiments in which the thermoplastic composition is a ready-for-forming formulation and the non-fluorinated hydrophobic additive comprises a type I primary fatty acid amide, the ready-for-forming formulation may comprise, based on a total weight of the thermoplastic composition: (a) non-fluorinated hydrophobic additive in an amount from about 0.07 wt. % to about 1 wt. %; (b) synergistic polymer additive in an amount from about 0.1 wt. % to about 3 wt. %; (c) thermoplastic polymer in an amount from about 55 wt. % to about 99.8 wt. %; optionally (d) secondary synergistic additive in an amount from 0 wt. % to about 1 wt. %; and optionally (e) other additives in an amount from 0 wt. % to about 40 wt. %.

For further example, in embodiments in which the thermoplastic composition is a ready-for-forming formulation and the non-fluorinated hydrophobic additive comprises a type II primary fatty acid amide, the ready-for-forming formulation may comprise, based on a total weight of the thermoplastic composition: (a) non-fluorinated hydrophobic additive in an amount from about 0.2 wt. % to about 3 wt. %; (b) synergistic polymer additive in an amount from about 0.3 wt. % to about 10 wt. %; (c) thermoplastic polymer in an amount from about 26 wt. % to about 99.5 wt. %; optionally (d) secondary synergistic additive in an amount from 0 wt. % to about 1 wt. %; and optionally (e) other additives in an amount from 0 wt. % to about 40 wt. %.

Without intending to be bound by theory, it is believed that improved hydrophobicity and/or enhanced durability of hydrophobicity may result at least in part from a hydrogen bonding interaction that may occur between the primary amide groups (i.e., —CO—NH₂) and/or the secondary amide groups (i.e., —CO—NH—R′) of the hydrophobic additive and the pendant epoxide groups or alkylene oxide repeating units of the synergistic polymer additive. Such an interaction may help retain the fatty acid amide molecules at the surface of the article formed from the thermoplastic composition. If both the molar mass of the fatty acid amide and the epoxy equivalent weight or alkylene oxide equivalent weight of the synergistic polymer additive are known, a useful molar ratio may be calculated from the weight ratio between the fatty acid amide and the synergistic polymer additive.

Accordingly, in embodiments in which the non-fluorinated hydrophobic additive comprises primary fatty acid amide, the non-fluorinated hydrophobic additive and the synergistic polymer additive may be present in the thermoplastic composition at such a weight ratio that corresponds to a molar ratio between moles of primary amide groups and/or the secondary amide groups of the hydrophobic additive and moles of pendant epoxide groups or alkylene oxide repeating units of the synergistic polymer additive that is about 2:1 to about 1:2.5, including any and all subranges formed from any of these endpoints.

Additionally, in embodiments, the secondary synergistic additive optionally may be present at a weight ratio from about 1:2 to about 1:1 relative to the weight of the non-fluorinated hydrophobic additive, including any and all subranges formed from any of these endpoints.

In embodiments, a specimen film formed from the thermoplastic composition may have a static water contact angle of at least about 102 degrees according to ASTM D5946.

### Non-Fluorinated Hydrophobic Additive

Thermoplastic compositions as disclosed herein comprise non-fluorinated hydrophobic additive comprising fatty acid amide. The non-fluorinated hydrophobic additive is included to impart hydrophobicity to the thermoplastic composition and articles formed therefrom.

Suitable non-fluorinated hydrophobic additive may include conventional or commercially available non-fluorinated hydrophobic additive comprising fatty acid amide. One type of non-fluorinated hydrophobic additive comprising fatty acid amide may be used alone or in combination with one or more other types of non-fluorinated hydrophobic additive comprising fatty acid amide.

In embodiments, the non-fluorinated hydrophobic additive may comprise at least one of a primary fatty acid amide and a secondary fatty acid amide.

For example, in embodiments, the fatty acid amide may have a structure of:

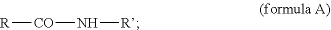

wherein R is an aliphatic hydrocarbon chain having from about 11 to about 29 carbons, and R′ is independently selected from H, R″, and —(CH₂)ₙ—NH—CO—R″; wherein R″ is an aliphatic hydrocarbon chain having from about 3 to about 29 carbons, and n is from 2 to 12.

As further example, in embodiments, the fatty acid amide may have a structure of formula A wherein R′ is H and R is selected from (i) a saturated and branched aliphatic hydrocarbon chain having from about 11 to about 29 carbons, and (ii) an unsaturated aliphatic hydrocarbon chain having a structure of:

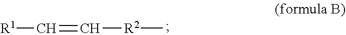

wherein: (i) each of R¹ and R² is a saturated hydrocarbon chain having at least 2 carbons, (ii) R¹ and R² together have a total number of carbons ranging from about 9 to about 27, and (iii) R¹ and R² are oriented as a cis isomer of the formula B (i.e., R¹ and R² are located on the same side of the carbon-carbon double bond of the formula B and forming a cis isomer).

In embodiments, the fatty acid amide may be a “type I primary fatty acid amide” which as used herein refers to a fatty acid amide having a structure of formula A wherein R′ is H and R is selected from an unsaturated aliphatic hydrocarbon chain having a structure of:

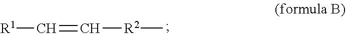

wherein: (i) each of R¹ and R² is a saturated hydrocarbon chain having at least 2 carbons, (ii) R¹ and R² together have a total number of carbons ranging from about 9 to about 27, and (iii) R¹ and R² are oriented as a cis isomer of the formula B (i.e., R¹ and R² are located on the same side of the carbon-carbon double bond of the formula B and form a cis isomer).

In embodiments, the fatty acid amide may be a “type II primary fatty acid amide” which as used herein refers to a fatty acid amide having a structure of:

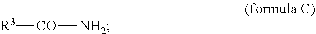

wherein R³ is a saturated and branched aliphatic hydrocarbon chain having from about 11 to about 29 carbons.

In embodiments, the non-fluorinated hydrophobic additive may comprise one or more selected from erucamide, oleamide, pamitoleamide, isostearamide, stearyl erucamide, stearyl oleamide, oleyl palmitamide, oleyl stearamide, stearyl stearamide, and ethylene bisstearamideic acid amide.

In embodiments in which the thermoplastic composition is a masterbatch formulation, the thermoplastic composition may comprise the non-fluorinated hydrophobic additive in an amount from about 2.5 wt. % to about 25 wt. %, based on a total weight of the thermoplastic composition. For example, in embodiments, the amount of the non-fluorinated hydrophobic additive may be greater than or equal to about 2.5 wt. %, greater than or equal to about 5 wt. %, greater than or equal to about 7.5 wt. %, greater than or equal to about 10 wt. %, greater than or equal to about 12.5 wt. %, or greater than or equal to about 15 wt. %; and less than or equal to about 25 wt. %, less than or equal to about 23 wt. %, less than or equal to about 20 wt. %, or less than or equal to about 17 wt. %; further, in embodiments, from about 2.5 wt. % to about 25 wt. %, from about 2.5 wt. % to about 23 wt. %, from about 2.5 wt. % to about 20 wt. %, from about 2.5 wt. % to about 17 wt. %, from about 5 wt. % to about 25 wt. %, from about 5 wt. % to about 23 wt. %, from about 5 wt. % to about 20 wt. %, from about 5 wt. % to about 17 wt. %, from about 7 wt. % to about 25 wt. %, from about 7 wt. % to about 23 wt. %, from about 7 wt. % to about 20 wt. %, from about 7 wt. % to about 17 wt. %, from about 10 wt. % to about 25 wt. %, from about 10 wt. % to about 23 wt. %, from about 10 wt. % to about 20 wt. %, from about 10 wt. % to about 17 wt. %, from about 13 wt. % to about 25 wt. %, from about 13 wt. % to about 23 wt. %, from about 13 wt. % to about 20 wt. %, from about 13 wt. % to about 17 wt. %, from about 15 wt. % to about 25 wt. %, from about 15 wt. % to about 23 wt. %, from about 15 wt. % to about 20 wt. %, or from about 15 wt. % to about 17 wt. %, or any and all sub-ranges formed from any of these endpoints.

In embodiments, loading levels of the non-fluorinated hydrophobic additive may be different depending on which type of non-fluorinated hydrophobic additive is used.

For example, in embodiments in which the thermoplastic composition is a ready-for-forming formulation and the non-fluorinated hydrophobic additive comprises a type I primary fatty acid amide, the thermoplastic composition may comprise the non-fluorinated hydrophobic additive in an amount from about 0.07 wt. % to about 1 wt. %, based on total weight of the thermoplastic composition. For example, in embodiments, the amount of the non-fluorinated hydrophobic additive may be greater than or equal to about 0.07 wt. %, greater than or equal to about 0.1 wt. %, greater than or equal to about 0.2 wt. %; or greater than or equal to about 0.3 wt. %; and less than or equal to about 1 wt. %, less than or equal to about 0.7 wt %, or less than or equal to about 0.5 wt. %; further, in embodiments, from about 0.07 wt. % to about 1 wt. %, from about 0.07 wt. % to about 0.7 wt. %, from about 0.07 wt. % to about 0.5 wt. %, from about 0.1 wt. % to about 1 wt. %, from about 0.1 wt. % to about 0.7 wt. %, from about 0.1 wt. % to about 0.5 wt. %, from about 0.2 wt. % to about 1 wt. %, from about 0.2 wt. % to about 0.7 wt. %, from about 0.2 wt. % to about 0.5 wt. %, from about 0.3 wt. % to about 1 wt. %, from about 0.3 wt. % to about 0.7 wt. %, from about 0.3 wt. % to about 0.5 wt. %, or any and all sub-ranges formed from any of these endpoints.

Suitable commercial embodiments of the non-fluorinated hydrophobic additive comprising a type I primary fatty acid amide include those available from Croda under the CRODAMIDE brand such as grade ER, which is primary amide of erucic acid (i.e., erucamide).

For further example, in embodiments in which the thermoplastic composition is a ready-for-forming formulation and the non-fluorinated hydrophobic additive comprises a type II primary fatty acid amide, the thermoplastic composition may comprise the non-fluorinated hydrophobic additive in an amount from about 0.2 wt. % to about 3 wt. %, based on total weight of the thermoplastic composition. For example, in embodiments, the amount of the non-fluorinated hydrophobic additive may be greater than or equal to about 0.2 wt. %, greater than or equal to about 0.3 wt. %, or greater than or equal to about 0.5 wt. %; and less than or equal to about 3 wt. %, less than or equal to about 2 wt. %, or less than or equal to about 1 wt. %; further, in embodiments, from about 0.2 wt. % to about 3 wt. %, from about 0.2 wt. % to about 2 wt. %, from about 0.2 wt. % to about 1 wt. %, from about 0.3 wt. % to about 3 wt. %, from about 0.3 wt. % to about 2 wt. %, from about 0.3 wt. % to about 1 wt. %, from about 0.5 wt. % to about 3 wt. %, from about 0.5 wt. % to about 2 wt. %, from about 0.5 wt. % to about 1 wt. %, or any and all sub-ranges formed from any of these endpoints.

Suitable commercial embodiments of the non-fluorinated hydrophobic additive comprising a type II primary fatty acid amide include those available from Croda under the INCROSLIP brand such as grade SL, which is primary amide of isostearic acid (i.e., isostearamide).

### Synergistic Polymer Additive

Thermoplastic compositions as disclosed herein comprise synergistic polymer additive comprising functional copolymer with pendant epoxide groups or alkylene oxide repeating units. The synergistic polymer additive is included to help improve the durability of hydrophobicity of the thermoplastic composition when an article formed from the thermoplastic composition is subjected to environmental aging such as heat aging.

Suitable synergistic polymer additive may include conventional or commercially available functional copolymer with pendant epoxide groups or alkylene oxide repeating units. One type of synergistic polymer additive may be used alone or in combination with one or more other types of synergistic polymer additive.

In embodiments, the synergistic polymer additive may comprise functional copolymer with pendant epoxide groups. For example, in embodiments, the synergistic polymer additive may comprise at least one of styrene-acrylic copolymer with pendant epoxide groups and ethylene-acrylic copolymer with pendant epoxide groups.

In embodiments, the synergistic polymer additive may comprise at least one of (i) styrene-acrylic copolymer with pendant epoxide groups and (ii) ethylene-acrylic copolymer with pendant epoxide groups, each of the styrene-acrylic copolymer and the ethylene-acrylic copolymer having an epoxy equivalent weight ranging from about 250 to about 3,000 and weight-averaged molecular weight ranging from about 5,000 to about 100,000.

In embodiments, the synergistic polymer additive may comprise at least one of (i) a styrene-acrylic copolymer with pendant epoxide groups and having an epoxy equivalent weight of about 250 to about 1,000 and weight-averaged molecular weight of between 5,000 and 20,000, and (ii) an ethylene-acrylic copolymer with pendant epoxide groups and having an epoxy equivalent weight of about 500 to about 3,000 and weight-averaged molecular weight of between 20,000 and 100,000.

In embodiments, the synergistic polymer additive may comprise functional copolymer with alkylene oxide repeating units. For example, in embodiments, the alkylene oxide repeating units having a structure of:

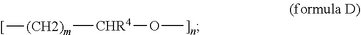

wherein m is an integer from about 1 to about 3; n is greater than 3; and R⁴ is H or a hydrocarbon side chain having from 1 to about 22 carbons.

For example, in embodiments, the alkylene oxide repeating units may be selected from one or more of ethylene oxide, propylene oxide, butylene oxide, and tetramethylene oxide.

Loading levels of the synergistic polymer additive may correlate to loading levels of the hydrophobic additive comprising fatty acid amide in the thermoplastic compositions as disclosed herein in order to achieve a synergistic effect and provide improved hydrophobicity and/or enhanced durability of hydrophobicity of the thermoplastic compositions. Indeed, it is believed that using too high a loading level of the synergistic polymer additive relative to the loading level of the non-fluorinated hydrophobic additive comprising fatty acid amide in a thermoplastic composition may negatively impact hydrophobicity (i.e., increase hydrophilicity) of the thermoplastic composition.

For example, in embodiments, an effective loading level of the synergistic polymer additive may be determined by using a target molar ratio of about 2:1 to about 1:2.5 between the moles of primary amide groups and/or the secondary amide groups of the hydrophobic additive and the moles of pendant epoxide groups or alkylene oxide repeating units of the synergistic polymer additive. If both the molar mass of the fatty acid amide and the epoxy equivalent weight or alkylene oxide equivalent weight of the synergistic polymer additive are known, a useful weight ratio between the fatty acid amide and the synergistic polymer additive may be calculated from the target molar ratio.

For example, in embodiments in which the thermoplastic composition is a masterbatch formulation, the thermoplastic composition may comprise synergistic polymer additive in an amount from about 2.5 wt. % to about 40 wt. %, based on a total weight of the thermoplastic composition. For example, in embodiments, the amount of the synergistic polymer additive may be greater than or equal to about 2.5 wt. %, greater than or equal to about 5 wt. %, greater than or equal to about 7.5 wt. %, greater than or equal to about 10 wt. %, greater than or equal to about 15 wt. %, or greater than or equal to about 20 wt. %; and less than or equal to about 40 wt. %, less than or equal to about 37.5 wt. %, less than or equal to about 35 wt. %, less than or equal to about 30 wt. %, or than or equal to about 25 wt. %; further, in embodiments, from about 2.5 wt. % to about 40 wt. %, from about 2.5 wt. % to about 37.5 wt. %, from about 2.5 wt. % to about 35 wt. %, from about 2.5 wt. % to about 30 wt. %, from about 0.5 wt. % to about 25 wt. %, from about 5 wt. % to about 40 wt. %, from about 5 wt. % to about 37.5 wt. %, from about 5 wt. % to about 35 wt. %, from about 5 wt. % to about 30 wt. %, from about 5 wt. % to about 25 wt. %, from about 7.5 wt. % to about 40 wt. %, from about 7.5 wt. % to about 37.5 wt. %, from about 7.5 wt. % to about 35 wt. %, from about 7.5 wt. % to about 30 wt. %, from about 7.5 wt. % to about 25 wt. %, from about 10 wt. % to about 40 wt. %, from about 10 wt. % to about 37.5 wt. %, from about 10 wt. % to about 35 wt. %, from about 10 wt. % to about 30 wt. %, from about 10 wt. % to about 25 wt. %, from about 15 wt. % to about 40 wt. %, from about 15 wt. % to about 37.5 wt. %, from about 15 wt. % to about 35 wt. %, from about 15 wt. % to about 30 wt. %, from about 15 wt. % to about 25 wt. %, from about 20 wt. % to about 40 wt. %, from about 20 wt. % to about 37.5 wt. %, from about 20 wt. % to about 35 wt. %, from about 20 wt. % to about 30 wt. %, or from about 20 wt. % to about 35 wt. %, or any and all sub-ranges formed from any of these endpoints.

For example, in embodiments in which the thermoplastic composition is a ready-for-forming formulation and the non-fluorinated hydrophobic additive comprises a type I primary fatty acid amide, the thermoplastic composition may comprise synergistic polymer additive in an amount from about 0.1 wt. % to about 3 wt. %, based on total weight of the thermoplastic composition. For example, in embodiments, the amount of the synergistic polymer additive may be greater than or equal to about 0.1 wt. %, greater than or equal to about 0.5 wt. %, greater than or equal to about 1 wt. %, or greater than or equal to about 1.2 wt. %; and less than or equal to about 3 wt. %, less than or equal to about 2.5 wt. %, or less than or equal to 2 wt. %; further, in embodiments, from about 0.1 wt. % to about 3 wt. %, from about 0.1 wt. % to about 2.5 wt. %, from about 0.1 wt. % to about 2 wt. %, from about 0.5 wt. % to about 3 wt. %, from about 0.5 wt. % to about 2.5 wt. %, from about 0.5 wt. % to about 2 wt. %, from about 1 wt. % to about 3 wt. %, from about 1 wt. % to about 2.5 wt. %, from about 1 wt. % to about 2 wt. %, or any and all sub-ranges formed from any of these endpoints.

For example, in embodiments in which the thermoplastic composition is a ready-for-forming formulation and the non-fluorinated hydrophobic additive comprises a type II primary fatty acid amide, the thermoplastic composition may comprise synergistic polymer additive in an amount from about 0.3 wt. % to about 10 wt. %, based on total weight of the thermoplastic composition. For example, in embodiments, the amount of the synergistic polymer additive may be greater than or equal to about 0.3 wt. %, greater than or equal to about 1 wt. %, or greater than or equal to about 2.5 wt. %; and less than or equal to about 10 wt. %, less than or equal to about 8 wt. %, or less than or equal to 7.5 wt. %; further, in embodiments, from about 0.3 wt. % to about 10 wt. %, from about 0.3 wt. % to about 8 wt. %, from about 0.3 wt. % to about 7.5 wt. %, from about 1 wt. % to about 10 wt. %, from about 1 wt. % to about 8 wt. %, from about 1 wt. % to about 7.5 wt. %, from about 2.5 wt. % to about 10 wt. %, from about 2.5 wt. % to about 8 wt. %, from about 2.5 wt. % to about 7.5 wt. %, or any and all sub-ranges formed from any of these endpoints.

Suitable commercial embodiments of the synergistic polymer additive include those available from BASF under the JONCRYL brand such as grade ADR 4468, which is styrene-acrylic copolymer with pendant epoxide groups and having epoxy equivalent weight of about 310 and weight-averaged molecular weight of about 7,250; and those available from Aldrich such as ethylene-acrylic copolymer with pendant epoxide groups and having epoxy equivalent weight of about 1,700 and weight-averaged molecular weight of about 50,000.

### Thermoplastic Polymer

Thermoplastic compositions as disclosed herein comprise thermoplastic polymer. The thermoplastic polymer may be selected based on end-use applications for the thermoplastic compositions and/or target performance properties and criteria for thermoplastic articles formed from the thermoplastic compositions.

Suitable thermoplastic polymer may include conventional or commercially available thermoplastic polymer. One type of thermoplastic polymer may be used alone or in combination with one or more other type of thermoplastic polymer.

In embodiments, the thermoplastic polymer may comprise one or more selected from polyethylenes, polypropylenes, polyolefin copolymers, cyclic olefin copolymers, ethylene vinyl acetate copolymers, polymethylpentenes, polystyrenes, styrenic block copolymers, polyamides, and polyamide copolymers.

In embodiments, the polyethlyenes may comprise a polyethylene homopolymer (i.e., composed of ethylene monomers) or a polyethylene copolymer having greater than 50 wt. % ethylene monomer and an additional co-monomer, such as C₃-C₁₂ alpha olefins.

In embodiments, the polypropylenes may comprise a polypropylene homopolymer (i.e., composed of propylene monomers) or a polypropylene copolymer having greater than 50 wt. % propylene monomer and an additional co-monomer such as C₂ and C₄-C₁₂ alpha olefins.

In embodiments in which the thermoplastic composition is a masterbatch formulation, the thermoplastic composition may comprise thermoplastic polymer as the carrier in an amount from about 25 wt. % to about 95 wt. %, based on a total weight of the thermoplastic composition.

For example, in embodiments, the amount of the thermoplastic polymer in the thermoplastic composition may be greater than or equal to about 25 wt. %, greater than or equal to about 30 wt. %, greater than or equal to about 40 wt. %, greater than or equal to about 45 wt. %, or greater than or equal to about 50 wt. %; and less than or equal to about 95 wt. %, less than or equal to about 90 wt. %, or less than or equal to 85 wt. %; further, in embodiments, from about 25 wt. % to about 95 wt. %, from about 25 wt. % to about 90 wt. %, from about 25 wt. % to about 85 wt. %, from about 30 wt. % to about 95 wt. %, from about 30 wt. % to about 90 wt. %, from about 30 wt. % to about 85 wt. %, from about 35 wt. % to about 95 wt. %, from about 35 wt. % to about 90 wt. %, from about 35 wt. % to about 85 wt. %, from about 40 wt. % to about 95 wt. %, from about 40 wt. % to about 90 wt. %, from about 40 wt. % to about 85 wt. %, from about 45 wt. % to about 45 wt. %, from about 45 wt. % to about 90 wt. %, from about 45 wt. % to about 85 wt. %, from about 50 wt. % to about 95 wt. %, from about 50 wt. % to about 90 wt. %, from about 50 wt. % to about 85 wt. %, or any and all sub-ranges formed from any of these endpoints.

In embodiments in which the thermoplastic composition is a masterbatch formulation, the thermoplastic polymer as the carrier may comprise one or more of linear low-density polyethylene, polyethylene wax, polybutadiene, ethylene vinyl acetate copolymers, and ethylene methyl acrylate copolymers.

In embodiments in which the thermoplastic composition is a ready-for-forming formulation, the thermoplastic composition may comprise thermoplastic polymer in an amount from about 26 wt. % to about 99.8 wt. %, based on a total weight of the thermoplastic composition. For example, in embodiments, the amount of the thermoplastic polymer in the thermoplastic composition may be greater than or equal to about 26 wt. %, greater than or equal to about 30 wt. %, greater than or equal to about 40 wt. %, greater than or equal to about 48 wt. %, greater than or equal to about 50 wt. %, greater than or equal to about 55 wt. %, or greater than or equal to about 60 wt. %; and less than or equal to about 99.8 wt. %, less than or equal to about 99.5 wt. %, less than or equal to 95 wt. %, or less than or equal to 90 wt. %; further, in embodiments, from about 26 wt. % to about 99.8 wt. %, from about 26 wt. % to about 99.5 wt. %, from about 26 wt. % to about 95 wt. %, from about 26 wt. % to about 90 wt. %, from about 30 wt. % to about 99.8 wt. %, from about 30 wt. % to about 99.5 wt. %, from about 30 wt. % to about 95 wt. %, from about 30 wt. % to about 90 wt. %, from about 40 wt. % to about 99.8 wt. %, from about 40 wt. % to about 99.5 wt. %, from about 40 wt. % to about 95 wt. %, from about 40 wt. % to about 90 wt. %, from about 48 wt. % to about 99.8 wt. %, from about 48 wt. % to about 99.5 wt. %, from about 48 wt. % to about 95 wt. %, from about 48 wt. % to about 90 wt. %, from about 50 wt. % to about 99.8 wt. %, from about 50 wt. % to about 99.5 wt. %, from about 50 wt. % to about 95 wt. %, from about 50 wt. % to about 90 wt. %, from about 55 wt. % to about 99.8 wt. %, from about 55 wt. % to about 99.5 wt. %, from about 55 wt. % to about 95 wt. %, from about 55 wt. % to about 90 wt. %, from about 60 wt. % to about 99.8 wt. %, from about 60 wt. % to about 99.5 wt. %, from about 60 wt. % to about 95 wt. %, from about 60 wt. % to about 90 wt. %, or any and all sub-ranges formed from any of these endpoints.

For example, in embodiments in which the thermoplastic composition is a ready-for-forming formulation and the non-fluorinated hydrophobic additive comprises a type I primary fatty acid amide, the thermoplastic composition may comprise thermoplastic polymer in an amount from about 48 wt. % to about 99.8 wt. %, based on total weight of the thermoplastic composition.

For further example, in embodiments in which the thermoplastic composition is a ready-for-forming formulation and the non-fluorinated hydrophobic additive comprises a type II primary fatty acid amide, the thermoplastic composition may comprise thermoplastic polymer in an amount from about 26 wt. % to about 99.5 wt. %, based on total weight of the thermoplastic composition.

Suitable commercial embodiments of the thermoplastic polymer include polypropylene homopolymers available from LyondellBasell under the PRO-FAX brand, such as PP grade PD702; from INEOS such as PP grade H35G; and from Braskem such as PP grade HP 648S.

### Secondary Synergistic Additive

In embodiments, thermoplastic compositions as disclosed herein may further comprise secondary synergistic additive comprising fatty acid.

The secondary synergistic additive may be included to further improve the durability of hydrophobicity of the thermoplastic composition when an article formed from the thermoplastic composition is subjected to environmental aging such as heat aging.

Suitable secondary synergistic additive may include conventional or commercially available fatty acid. One type of secondary synergistic additive may be used alone or in combination with one or more other types of secondary synergistic additive.

In embodiments, the secondary synergistic additive may comprise fatty acid having a structure of R⁵COOH wherein R⁵ is an unbranched aliphatic hydrocarbon chain having about 11 to about 29 carbons.

In embodiments in which the thermoplastic composition is a masterbatch formulation, the thermoplastic composition may comprise secondary synergistic additive in an amount from 0 wt. % to about 10 wt. %, based on a total weight of the thermoplastic composition. For example, in embodiments, the amount of the secondary synergistic additive may be greater than or equal to 0 wt. %, greater than or equal to about 1 wt. %, greater than or equal to about 2 wt. %, greater than or equal to about 5 wt. %; and less than or equal to about 10 wt. %, less than or equal to about 7.5 wt. %; further, in embodiments, from 0 wt. % to about 10 wt. %, from 0 wt. % to about 7.5 wt. %, from 0 wt. % to about 5 wt. %, from about 1 wt. % to about 10 wt. %, from about 1 wt. % to about 7.5 wt. %, from about 1 wt. % to about 5 wt. %, from about 2 wt. % to about 10 wt. %, from about 2 wt. % to about 7.5 wt. %, from about 5 wt. % to about 10 wt. %, from about 5 wt. % to about 7.5 wt. %, or any and all sub-ranges formed from any of these endpoints.

In embodiments in which the thermoplastic composition is a ready-for-forming formulation, the thermoplastic composition may comprise secondary synergistic additive in an amount from 0 wt. % to about 1 wt. %, based on a total weight of the thermoplastic composition. For example, in embodiments, the amount of the secondary synergistic additive may be greater than or equal to 0 wt. %, greater than or equal to about 0.1 wt. %, greater than or equal to about 0.2 wt. %, greater than or equal to about 0.5 wt. %; and less than or equal to about 1 wt. %, or less than or equal to about 0.7 wt. %; further, in embodiments, from 0 wt. % to about 1 wt. %, from 0 wt. % to about 0.7 wt. %, from about 0.1 wt. % to about 1 wt. %, from about 0.1 wt. % to about 0.7 wt. %, from about 0.2 wt. % to about 1 wt. %, from about 0.2 wt. % to about 0.7 wt. %, from about 0.5 wt. % to about 1 wt. %, from about 0.5 wt. % to about 0.7 wt. %, or any and all sub-ranges formed from any of these endpoints.

Suitable commercial embodiments of the secondary synergistic additive include stearic acid available from Aldrich.

### Other Additives

In embodiments, thermoplastic compositions as disclosed herein may further comprise one or more optional other additives.

Suitable other additives may include conventional or commercially available plastics additives. Those skilled in the art of thermoplastics compounding, without undue experimentation, may select suitable additives from available references, for example, E. W. Flick, “Plastics Additives Database,” Plastics Design Library (Elsevier 2004).

Optional other additives may be used in any amount that is sufficient to obtain a desired processing or performance property for the material or component formed therefrom. The amount should not be wasteful of the additive nor detrimental to the processing or performance of the material or article formed therefrom.

Non-limiting examples of optional other additives may include one or more of antioxidants; nucleating agents; colorants (e.g., pigments and/or dyes); inorganic mineral fillers; mineral oils, flame retardants; glass beads, glass flakes, and glass fibers; impact modifiers; micas; slip and anti-blocking agents; ultraviolet light absorbers; and waxes.

In embodiments in which the thermoplastic composition is a masterbatch formulation, the thermoplastic composition may comprise other additives in an amount from 0 wt. % to about 5 wt. %, based on a total weight of the thermoplastic composition. For example, in embodiments, the amount of the other additives in the thermoplastic composition may be greater than or equal to 0 wt. %, greater than or equal to about 1 wt. %, or greater than or equal to about 2 wt. %; and less than or equal to about 5 wt. %, or less than or equal to about 3 wt. %; further, in embodiments, from 0 wt. % to about 5 wt. %, from 0 wt. % to about 3 wt. %, from about 1 wt. % to about 5 wt. %, from about 1 wt. % to about 3 wt. %, from about 2 wt. % to about 5 wt. %, or from about 2 wt. % to about 3 wt. %, or any and all sub-ranges formed from any of these endpoints.

In embodiments in which the thermoplastic composition is a ready-for-forming formulation, the thermoplastic composition may comprise other additives in an amount from 0 wt. % to about 40 wt. %, based on a total weight of the thermoplastic composition. For example, in embodiments, the amount of the other additives in the thermoplastic composition may be greater than or equal to 0 wt. %, greater than or equal to about 1 wt. %, greater than or equal to 5 wt. %, or greater than or equal to 10 wt. %; and less than or equal to about 40 wt. %, less than or equal to about 30 wt. %, or less than or equal to about 20 wt. %; further, in embodiments, from 0 wt. % to about 40 wt. %, from 0 wt. % to about 30 wt. %, from 0 wt. % to about 20 wt. %, from about 1 wt. % to about 40 wt. %, from about 1 wt. % to about 30 wt. %, from about 1 wt. % to about 20 wt. %, from about 5 wt. % to about 40 wt. %, from about 5 wt. % to about 30 wt. %, from about 5 wt. % to about 20 wt. %, from about 10 wt. % to about 40 wt. %, from about 10 wt. % to about 30 wt. %, or from about 10 wt. % to about 20 wt. %, or any and all sub-ranges formed from any of these endpoints.

It should be understood that suitable loading levels of the other additives may depend on the type(s) of the other additives that are used. For example, upper endpoints such as 40 wt. %, 30 wt. % or 20 wt. % may be more typically applicable for other additives such as inorganic mineral fillers and glass beads, glass flakes, and/or glass fibers, and less typically applicable or not applicable for other additives such as antioxidants.

### Processing

In embodiments, thermoplastic compositions as disclosed herein may be made with a batch process or a continuous process.

In embodiments, components of the thermoplastic composition, including non-fluorinated hydrophobic additive, synergistic polymer additive, thermoplastic polymer, and, optionally, other additives, may be added may be added to an extruder and melt-mixed. In embodiments, the melt-mixing (e.g., in the barrel of the extruder) may be carried out at a temperature from about 210° C. to about 230° C.

Non-limiting examples of processing techniques are described in available references, for example, Dominick V. Rosato et al., Plastics Design Handbook (Springer 2013).

### Thermoplastic Article

Thermoplastic compositions as disclosed herein may be used to form any thermoplastic article that requires improved hydrophobicity and/or enhanced durability of hydrophobicity without the use of fluorinated compounds. Accordingly, thermoplastic articles may be formed from the thermoplastic compositions as disclosed herein, and the thermoplastic articles may be free of fluorine and fluorinated substances.

In embodiments, at least a portion of the non-fluorinated hydrophobic additive may be present at an outer surface of the thermoplastic article in an amount sufficient to provide a desirable level of hydrophobicity on the outer surface both before and after the thermoplastic article is subjected to environmental aging such as heat aging. Further, in embodiments, at least a portion of the synergistic polymer additive may be present at the outer surface of the thermoplastic article along with at least a portion of the non-fluorinated hydrophobic additive.

In embodiments, the non-fluorinated hydrophobic additive may be intermixed throughout the thermoplastic article because the non-fluorinated hydrophobic additive is incorporated into the thermoplastic composition used for forming the thermoplastic article. Likewise, in embodiments, at least a portion of the synergistic polymer additive may be intermixed throughout the thermoplastic article because the synergistic polymer additive is incorporated into the thermoplastic composition used for forming the thermoplastic article.

In embodiments, neither the non-fluorinated hydrophobic additive nor the synergistic polymer additive is applied to the thermoplastic article as a surface coating or surface treatment composition as a separate or subsequent step after the thermoplastic article is formed.

In embodiments, the thermoplastic article may be formed from the thermoplastic composition into a useful form by one or more processes selected from extrusion, injection molding, blow molding, extrusion coating, rotational molding, spinning, thermoplastic pultrusion, and thermoforming.

In embodiments, the thermoplastic article may be a useful form selected from fibers; films and sheets; laminates; nonwoven fabrics; pellets; and three-dimensional formed parts.

In embodiments, the thermoplastic article may be laboratory plasticware or a component thereof. For example, in embodiments, the laboratory plasticware is one or more selected from beakers, bottles, containers, dishes, flasks, funnels, jars, pipettes, pipette tips, tubes, vials, etc.

In embodiments, the thermoplastic article may have one or both of a haze of less than or equal to about 70% and a transmittance of greater than or equal to about 85%, each according to ASTM D1003 and at a specimen thickness of 0.8 mm. A relatively low haze (e.g., less than or equal to about 70%) and/or a relatively high transmittance (e.g., greater than or equal to about 85%) may be desired in certain applications. For example, in laboratory plasticware applications such as pipette tips, it is desirable to see through the thermoplastic article to see the amount of liquid contained therein.

In embodiments, the thermoplastic article may be a medical article and/or personal care article and/or personal protection article or a component thereof. For example, in embodiments, the medical article and/or personal care article and/or personal protection article is one or more selected from gowns, drapes, curtains, dressings, aprons, coverings, pads, etc.

### Multilayer Article

Multilayer articles may be formed from the thermoplastic compositions as disclosed herein. The multilayer articles may be free of fluorine and fluorinated substances.

In embodiments, multilayer articles as disclosed herein may comprise an outer layer formed from the thermoplastic composition disclosed herein and an inner layer formed from a material excluding the thermoplastic composition.

In embodiments, the outer layer may be a thermoplastic article as disclosed herein.

### System

Systems as disclosed herein may comprise a component formed from the thermoplastic composition described herein in combination with an aqueous liquid in physical contact with at least a portion of the component.

In embodiments, the component may be a thermoplastic article and/or multilayer article as disclosed herein.

In embodiments, the aqueous liquid may comprise one or more bodily fluids or secretions such as blood, urine, saliva, etc. In further embodiments, the aqueous liquid may comprise or pharmaceutical compositions or testing/diagnostic/reagent compositions.

### Method of Imparting Hydrophobicity

Methods of imparting hydrophobicity to a surface of a thermoplastic article may comprise the step of forming the thermoplastic article from the thermoplastic composition described herein.

In embodiments, the method imparts improved hydrophobicity and/or enhanced durability of hydrophobicity to the surface of the thermoplastic article.

### EXAMPLES

Non-limiting examples of various embodiments of the disclosed invention are provided.

Table 1 below shows sources of ingredients used to form Comparative Examples C1 to C8 and Examples E1 to E7.

TABLE 1

| Ingredient | Chemical Description | Brand and Grade | Source |
|---|---|---|---|
| Thermoplastic polymer | Polypropylene homopolymer | PRO-FAX PD702 | LyondellBasell |
| Non-fluorinated | Primary amide of erucic acid | CRODAMIDE ER | Croda |
| hydrophobic additive | | | |
| Non-fluorinated | Primary amide of isostearic acid | INCROSLIP SL | Croda |
| hydrophobic additive | | | |
| Synergistic polymer | Styrene-acrylic copolymer having | JONCRYL ADR | BASF |
| additive | pendant epoxide groups, epoxy | 4468 | |
| | equivalent weight of 310, and | | |
| | averaged molecular weight of | | |
| | 7250 | | |
| Synergistic polymer | Ethylene-acrylic copolymer | [none] [referred to as | Aldrich |
| additive | having pendant epoxide groups, | PE-CO-GMA] | |
| | epoxy equivalent weight of 1700, | | |
| | and weight-averaged molecular | | |
| | weight of about 50,000 | | |
| Secondary synergistic | Stearic acid | [none] [referred to as | Aldrich |
| additive (optional) | | STEARIC ACID] | |
| Other additive | Mixture of hindered phenol and | IRGANOX B225 | BASF |
| (optional) | phosphite antioxidant | | |

Preparation of masterbatch formulations—For each of Comparative Examples C2 to C8 and Examples E1 to E7, a masterbatch formulation comprising ten times (10×) the final concentration of corresponding additives as listed in Table 2 and PRO-FAX PD702 (polypropylene homopolymer) carrier resin were intermixed thoroughly and extruded using a co-rotating twin-screw extruder with a 18 mm screw diameter, 40 length/screw diameter and moderate-shear screw design, and melt temperature between 210° C. to 230° C. Each masterbatch formulation was immediately cooled down and pelletized after exiting the twin-screw extruder.

Let-down of the additive concentrate formulation and injection molding process—Each additive concentrate formulation was premixed with neat PRO-FAX PD702 resin using a weight ratio of 10:90. The premix was fed into the injection molding machine, melted, and molded into flat plaques having dimensions of 100 mm×100 mm×0.8 mm and smooth surfaces on both sides of the plaque. The final concentrations of the additives in the plaque form of each let-down formulation are consistent with those of each example as listed in Table 2. The melt temperature of the injection molding process was controlled between 220° C. to 250° C. for all the examples. The molded plaques were then cut into 100 mm long x 25 mm wide plaques of the same thickness as test specimen for the residual dye test.

### Residual Dye Test

Conditioning of plaques—The plaque samples of each example composition were conditioned at ambient conditions for 240 hours or at 75° C. for 120 hours as indicated in Table 2.

Preparation of dye test solution and calibration curve between the absorbance and dye concentration—5 mL of food-grade green dye concentrate liquid (Fisher Science Education, Catalog #S05376) and 55 mL of deionized (DI) water were stirred to mix the dye concentrate an form a homogenous test solution. A portion of the test solution was diluted into concentrations between 0.4 μL/mL and 0.1 μL/mL (dye concentrate volume/total volume of the solution) by adding additional DI water and at least 3 concentration levels within the above dilution range. UV-Vis spectra of each diluted solution was collected using a UV-Vis spectrometer. A calibration curve was created using the absorption band present at 415 nm (i.e., one of the characteristic absorption bands of the green dye solution) by plotting absorbance at 415 nm versus concentrations of the diluted solutions and conducting a linear regression. A R-Squared value of greater than 0.99 was obtained for the linear regression, which is consistent with the Beer-Lambert law.

Dipping and UV-VIS test procedure—The green dye test solution was poured into a flat bottom beaker to an about 60 mm tall liquid level. The top edge of a flat plaque specimen of 100 mm long×25 mm wide×0.8 mm thick was held with the length direction of the plaque along the vertical direction. The plaque was vertically dipped into the test solution in the beaker and the bottom edge of the specimen was rested on the bottom of the beaker, such that the immersion depth of the specimen was about 60 mm. The plaque was pulled vertically and completely out of the test solution in the beaker with a speed between 125 mm/s to 250 mm/s. The specimen was held steadily and vertically above the beaker while waiting for the liquid film at the sample surfaces to complete de-wetting and also for the droplets accumulated at the bottom edge of the plaque to drip under their own weight back into the beaker. The plaque containing the residue liquid on its flat surfaces was placed into a second dry beaker and 10 mL of DI water (5 mL per side of the plaque) was dispensed to adequately rinse the dye from the plaque. A homogenous liquid sample of the rinsed off solution in the second beaker was collected and the sample's UV-Vis spectra and absorbance value at 415 nm were collected. This process was repeated for two additional plaque specimens for each example formulation and aging condition. The absorbance of the three total plaque specimens were averaged.

Residue liquid determined by a gravimetric test procedure—The UV-vis method to quantify the residue liquid may be less convenient to use because it requires a UV-vis calibration curve for specific dyes used in the test. As such, different dye solutions may require different calibration curves because of differences in absorption coefficients between dyes. An alternative approach to quantify the amount of the residue liquid on the sample surface after the sample surface's exposure to the liquid is a gravimetric method. This method does not require a dye in the test fluid although dye was still used in the applicable examples below as visual assistance to see where the residue liquid was located on the surface after the dipping step. To perform the gravimetric method, 5 replicate flat plaque specimens were prepared with smooth surfaces and size of 100 mm long x 75 mm wide×0.8 mm thick. The plaque specimens were conditioned at ambient condition for 240 hours or at 75° C. for 120 hours (i.e., sample aging condition). A fresh test liquid (a green dye water solution was used as test fluid in the examples of this invention) was prepared. The initial total weight of 5 dry plaque specimen was weighed. Like the dipping step described above with the UV-Vis procedure, each specimen was dipped and then pulled at moderate speed (a speed between 125 mm/s to 250 mm/s) out of the test liquid. The wet specimen was transferred into a secondary dry beaker, and the total weight of the 5 wet specimen (with residue liquid on their surfaces) was weighed after deducting the weight of the dry beaker. From the difference between the dry and wet weights of the 5 specimen, the averaged amount of residue liquid per specimen (in unit of miligram/plaque) was measured and reported for the sample tested under the specific aging condition.

Table 2 below shows the formulations (in wt. %, based on a total weight of the thermoplastic composition) used to form and test results for Comparative Examples C1 to C8 and Examples E1 to E7. The averaged residue dye values of each example (which was conditioned either at ambient conditions for 240 hours or at 75° C. for 120 hours) are included in the results. The relative standard deviation of the residue dye test result among the 3 repeated measurement of each sample is about 15% for Comparable Examples C3 to C8 and Examples El to E7 while the relative standard deviation of the residue dye test result of Comparative Examples C1 and C2 is about 40%. The significantly larger relative standard deviation of the residue dye result in Comparative Examples C1 and C2 (which also have poor hydrophobicity) indicates a very non-uniform surface performance between replicate specimens of each of those samples.

TABLE 2

| Example | | C1 | C2 | C3 | C4 |
|---|---|---|---|---|---|
| Ingredients | | | | | |
| PRO-FAX PD702 | | 100 | 99.465 | 99.440 | 99.915 |
| IRGANOX B225 | | — | 0.010 | 0.010 | 0.010 |
| CRODAMIDE ER | | — | 0.025 | 0.050 | 0.075 |
| INCROSLIP SL | | — | — | — | — |
| JONCRYL ADR 4468 | | — | 0.500 | 0.500 | — |
| PE-CO-GMA | | — | — | — | — |
| STEARIC ACID | | — | — | — | — |
| Total | | 100 | 100 | 100 | 100 |
| Test Results | | | | | |
| Property | Aging Condition | | | | |
| Residual dye | 240 hours at ambient condition | 0.5 | 0.4 | 0.2 | 0.0 |
| determined by the | 120 hours at 75° C. | 0.9 | 0.4 | 0.3 | 0.2 |
| UV-Vis method | Difference | +0.4 | 0.0 | +0.2 | +0.2 |
| Transmittance | 240 hours at ambient condition | 89 | 89 | 85 | 88 |
| (%) | 120 hours at 75° C. | 87 | 89 | 86 | 88 |
| | Difference | −2 | −1 | 1 | −1 |
| Haze (%) | 240 hours at ambient condition | 47 | 49 | 43 | 41 |
| | 120 hours at 75° C. | 48 | 56 | 62 | 64 |
| | Difference | 0 | +7 | +19 | +23 |
| Example | | C5 | C6 | E1 | E2 |
| Ingredients | | | | | |
| PRO-FAX PD702 | | 99.840 | 99.803 | 99.765 | 99.728 |
| IRGANOX B225 | | 0.010 | 0.010 | 0.010 | 0.010 |
| CRODAMIDE ER | | — | — | 0.075 | 0.075 |
| INCROSLIP SL | | — | — | — | — |
| JONCRYL ADR 4468 | | 0.150 | 0.150 | 0.150 | 0.150 |
| PE-CO-GMA | | — | — | — | — |
| STEARIC ACID | | — | 0.038 | — | 0.038 |
| Total | | 100 | 100 | 100 | 100 |
| Test Results | | | | | |
| Property | Aging Condition | | | | |
| Residual dye | 240 hours at ambient condition | 0.2 | 0.1 | 0.0 | 0.0 |
| (UV-Vis method) | 120 hours at 75° C. | 0.2 | 0.3 | 0.1 | 0.1 |
| | Difference | 0.0 | +0.2 | +0.1 | +0.1 |
| Transmittance | 240 hours at ambient condition | 88 | 89 | 89 | 89 |
| (%) | 120 hours at 75° C. | 89 | 89 | 89 | 89 |
| | Difference | 1 | 0 | 0 | 0 |
| Haze (%) | 240 hours at ambient condition | 46 | 48 | 51 | 49 |
| | 120 hours at 75° C. | 53 | 49 | 64 | 63 |
| | Difference | 7 | 1 | 13 | 14 |
| Example | | E3 | E4 | E5 | C7 |
| Ingredients | | | | | |
| PRO-FAX PD702 | | 99.615 | 99.290 | 99.728 | 99.915 |
| IRGANOX B225 | | 0.010 | 0.010 | 00.010 | 0.010 |
| CRODAMIDE ER | | 0.125 | 0.200 | 0.075 | — |
| INCROSLIP SL | | — | — | — | 0.075 |
| JONCRYL ADR 4468 | | 0.250 | 0.400 | — | — |
| PE-CO-GMA | | — | — | 0.150 | — |
| STEARIC ACID | | — | 0.100 | 0.038 | — |
| Total | | 100 | 100 | 100 | 100 |
| Test Results | | | | | |
| Property | Aging Condition | | | | |
| Residual dye | 240 hours at ambient condition | 0.1 | 0.0 | 0.0 | 0.1 |
| (UV-Vis method) | 120 hours at 75° C. | 0.1 | 0.0 | 0.1 | 0.4 |
| | Difference | 0.0 | 0.0 | +0.1 | +0.3 |
| Transmittance | 240 hours at ambient condition | 88 | 88 | 89 | 89 |
| (%) | 120 hours at 75° C. | 88 | 87 | 89 | 88 |
| | Difference | 0 | −1 | 0 | 0 |
| Haze (%) | 240 hours at ambient condition | 42 | 45 | 36 | 45 |
| | 120 hours at 75° C. | 52 | 71 | 56 | 52 |
| | Difference | 10 | 25 | 19 | 7 |

| Example | | C8 | E6 | E7 |
|---|---|---|---|---|
| Ingredients | | | | |
| PRO-FAX PD702 | | 99.728 | 99.290 | 98.490 |
| IRGANOX B225 | | 0.010 | 0.010 | 0.010 |
| CRODAMIDE ER | | — | — | — |
| INCROSLIP SL | | 0.075 | 0.200 | 0.500 |
| JONCRYL ADR 4468 | | 0.150 | 0.400 | 1.000 |
| PE-CO-GMA | | — | — | — |
| STEARIC ACID | | 0.038 | 0.100 | — |
| Total | | 100 | 100 | 100 |
| Test Results | | | | |
| Property | Aging Condition | | | |
| Residual dye | 240 hours at ambient | 0.3 | 0.1 | 0.1 |
| (UV-Vis method) | condition | | | |
| | 120 hours at 75° C. | 0.4 | 0.1 | 0.1 |
| | Difference | +0.1 | 0.0 | 0.0 |
| Transmittance | 240 hours at ambient | 89 | 88 | 86 |
| (%) | condition | | | |
| | 120 hours at 75° C. | 89 | 88 | 86 |
| | Difference | 0 | 0 | 0 |
| Haze (%) | 240 hours at ambient | 37 | 38 | 60 |
| | condition | | | |
| | 120 hours at 75° C. | 44 | 44 | 66 |
| | Difference | 8 | 7 | 6 |

Examples E1 to E7, which are thermoplastic compositions including PRO-FAX PD702 (thermoplastic polymer), CRODAMIDE ER or INCROSLIP SL (non-fluorinated hydrophobic additive), JONCRYL ADR 4468 or PE-CO-GMA (synergistic polymer additive), optionally STEARIC ACID (secondary synergistic additive), and optionally IRGANOX B225 (other additive), had a lower amount of residual dye after conditioning for 240 hours at ambient condition than Comparative Example C1, which is a thermoplastic composition including PRO-FAXPD702. As exemplified by Examples E1 to E7 and Comparative Example C1, thermoplastic compositions including both non-fluorinated hydrophobic additive and synergistic polymer additive had a greater hydrophobicity than thermoplastic compositions that do not include non-fluorinated hydrophobic additive and synergistic polymer additive.

Examples E1 to E7, which are thermoplastic compositions including PRO-FAX PD702 (thermoplastic polymer), at least 0.07 wt. % of CRODAMIDE ER or at least 0.2 wt % of INCROSLIP SL (non-fluorinated hydrophobic additive), JONCRYL ADR 4468 or PE-CO-GMA (synergistic polymer additive), optionally STEARIC ACID (secondary synergistic additive), and optionally IRGANOX B225 (other additive), had a lower amount of residual dye after conditioning for 120 hours at 75° C. than Comparative Examples C2 to C8, which are either (A) thermoplastic compositions including PRO-FAX PD702 (thermoplastic polymer) and at least about 0.07 wt. % of CRODAMIDE ER and/or INCROSLIP SL (non-fluorinated hydrophobic additive) but no JONCRYL ADR 4468 or PE-CO-GMA (synergistic polymer additive), optionally STEARIC ACID (secondary synergistic additive), and optionally IRGANOX B225 (other additive); or (B) thermoplastic compositions including PRO-FAX PD702 (thermoplastic polymer) and JONCRYL ADR 4468 or PE-CO-GMA (synergistic polymer additive) but less than about 0.07 wt. % of CRODAMIDE ER or less than 0.2 wt % of INCROSLIP SL (non-fluorinated hydrophobic additive), optionally STEARIC ACID (secondary synergistic additive), and optionally IRGANOX B225 (other additive).

The difference between residual dye after heat aging (conditioned at 75° C. for 120 hours) relative to residual dye after ambient aging (conditioned at ambient condition for 240 hours) was less for each of Examples E1 to E7 as compared to Comparative Examples C2 to C4 and C6 to C8. Although the difference for C5 was comparable to the differences for Examples E1 to E7, C5 had higher residual dye after both ambient aging and heat aging as compared to Examples E1 to E7.

As exemplified by Examples E1 to E7 and Comparative Examples C4 and C7, thermoplastic compositions including non-fluorinated hydrophobic additive and synergistic polymer additive have a greater durability of hydrophobicity than thermoplastic compositions including non-fluorinated hydrophobic additive but no synergistic polymer additive.

Note that the transmittance and haze values of the examples after conditioning at 75° C. for 120 hours did not differ greatly from the transmittance and haze values after conditioning at ambient condition for 240 hours.

Table 3 below shows the formulations (in wt. %, based on a total weight of the thermoplastic composition) used to form and test results for Comparative Example C1 and Examples E8 to E10, using the gravimetric method as described above to measure the residue liquid on the surface of each sample conditioned at ambient temperature (23° C.) for 240 hours or at 75° C. for 120 hours.

TABLE 3

| Example | | C1 | E8 | E9 | E10 |
|---|---|---|---|---|---|
| Ingredients | | | | | |
| PRO-FAX PD702 | | 100 | 99.03 | 99.25 | 99.46 |
| IRGANOX B225 | | — | 0.01 | 0.01 | 0.01 |
| CRODAMIDE ER | | — | 0.32 | 0.32 | 0.32 |
| (erucamide molar mass = 337.6 g/mol) | | | | | |
| INCROSLIP SL | | — | — | — | — |
| JONCRYL ADR 4468 | | — | 0.64 | 0.42 | 0.21 |
| (epoxy equivalent weight = 310 g/mol) | | | | | |
| Total | | 100 | 100 | 100 | 100 |
| Mole ratio between amide | | n/a | 1:2.2 | 1:1.4 | 1.4:1 |
| group of CRODAMIDE ER and | | | | | |
| epoxy group of JONCRYL ADR 4468 | | | | | |
| Test Results | | | | | |
| Property | Aging Condition | | | | |
| Residual dye | 240 hours at ambient condition | 53 | 8 | 10 | 9 |
| (gravimetric | 120 hours at 75° C. | 82 | 10 | 13 | 8 |
| method) | Difference | +28 | +2 | +3 | −1 |

Examples E8 to E10, which are thermoplastic compositions including PRO-FAX PD702 (thermoplastic polymer), CRODAMIDE ER (non-fluorinated hydrophobic additive), JONCRYL ADR 4468 (synergistic polymer additive), and optionally IRGANOX B225 (other additive), all had a similar amount of residual liquid (i.e., around 10 mg/plaque) which is significantly lower than those of Comparative Example C1 for the both sample conditionings (i.e., 240 hours at ambient condition and 120 hours at 75° C.). With the molar mass of CRODAMIDE ER (i.e., erucamide) being 337.6 g/mol and the epoxy equivalent weight of JONCRYL ADR 4468 being 310 g/mol, the molar ratio between the amide group of CRODAMIDE ER and epoxy group of JONCRYL ADR 4468 in the each of Examples E8 to E10 was calculated from the corresponding ingredient weight ratios, and, as shown in Table 3, varied from 1:2.2 in Example E8, to 1:1.4 in Example 9, to 1.4:1 in Example E10. In view of above, it is believed that the thermoplastic compositions of embodiments of the present invention wherein the molar ratio between amide group of the fatty acid amide additive and epoxy group of the synergistic polymer additive ranges from 2:1 (mole/mole) to 1:2.5 (mole/mole) may have both good initial hydrophobicity and enhanced durability of hydrophobicity (subject to heat aging).

Every document cited herein is incorporated herein by reference in its entirety unless otherwise specified. The citation of any document is not to be construed as an admission that it is prior art with respect to any invention disclosed or claimed herein. To the extent that any meaning or definition of a term in this document conflicts with any meaning or definition of the same term in a document incorporated by reference, the meaning or definition assigned to that term in this document shall govern.

It will be apparent that modifications and variations are possible without departing from the scope of the disclosure defined in the appended claims. Although some aspects of the present disclosure are identified herein as preferred or particularly advantageous, it is contemplated that the present disclosure is not necessarily limited to these aspects. The present disclosure extends to equivalents of aspects expressly described herein, all of which are considered to be within the scope of the present disclosure and covered by the following claims.

1. A thermoplastic composition comprising:
(a) non-fluorinated hydrophobic additive comprising fatty acid amide;
(b) synergistic polymer additive comprising functional thermoplastic copolymer with pendant epoxide groups or alkylene oxide repeating units; and
(c) thermoplastic polymer;
wherein the thermoplastic composition is free of fluorine and fluorinated substances.

2. The thermoplastic composition of claim 1, wherein the fatty acid amide has a structure of: 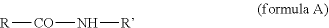
wherein:
R is an aliphatic hydrocarbon chain having from about 11 to about 29 carbons; and
R′ is independently selected from:
H;
R″; and 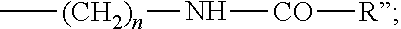
wherein:
R″ is an aliphatic hydrocarbon chain having from about 3 to about 29 carbons; and
n is from 2 to 12.

3. The thermoplastic composition of claim 1, wherein the fatty acid amide has a structure of: 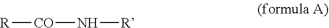
wherein:
R′ is H; and
R is selected from:
a saturated and branched aliphatic hydrocarbon chain having from about 11 to about 29 carbons; and
an unsaturated aliphatic hydrocarbon chain having a structure of: 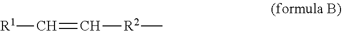
wherein:
each of R¹ and R² is a saturated hydrocarbon chain having at least 2 carbons;
R¹ and R² together have a total number of carbons ranging from about 9 to about 27; and
R¹ and R² are oriented as a cis isomer of the formula B.

4. The thermoplastic composition of claim 1, wherein the non-fluorinated hydrophobic additive comprises one or more selected from the group consisting of erucamide, oleamide, pamitoleamide, isostearamide, stearyl erucamide, stearyl oleamide, oleyl palmitamide, oleyl stearamide, stearyl stearamide, and ethylene bisstearamide.

5. The thermoplastic composition of claim 1, wherein the synergistic polymer additive comprises at least one of styrene-acrylic copolymer comprising pendant epoxide groups and ethylene-acrylic copolymer comprising pendant epoxide groups, each of the styrene-acrylic copolymer and the ethylene-acrylic copolymer having an epoxy equivalent weight ranging from about 250 to about 3,000 and a weight-averaged molecular weight ranging from about 5,000 to about 100,000.

6. The thermoplastic composition of claim 1, wherein the thermoplastic polymer comprises one or more selected from the group consisting of polyethylenes, polypropylenes, polyolefin copolymers, cyclic olefin copolymers, ethylene vinyl acetate copolymers, polymethylpentenes, polystyrenes, styrenic block copolymers, polyamides, and polyamide copolymers.

7. The thermoplastic composition of claim 1, further comprising secondary synergistic additive comprising fatty acid having a structure of R⁴—COOH wherein R⁴ is an unbranched hydrocarbon chain having from about 11 to about 29 carbons.

8. (canceled)

9. The thermoplastic composition of claim 1, wherein the thermoplastic composition is a ready-for-forming formulation comprising, based on a total weight of the thermoplastic composition:
(a) non-fluorinated hydrophobic additive in an amount from about 0.07 wt. % to about 1 wt. %;
(b) synergistic polymer additive in an amount from about 0.1 wt. % to about 3 wt. %;
(c) thermoplastic polymer in an amount from about 55 wt. % to about 99.8 wt. %;
(d) optionally, secondary synergistic additive in an amount from 0 wt. % to about 1 wt. %; and
(e) optionally, other additives in an amount from 0 wt. % to about 40 wt. %;
wherein the non-fluorinated hydrophobic additive comprises fatty acid amide having a structure of: 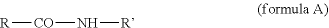
wherein R′ is H and R is an unsaturated aliphatic hydrocarbon chain having a structure of: 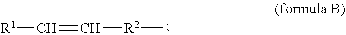
wherein (i) each of R¹ and R² is a saturated hydrocarbon chain having at least 2 carbons, (ii) R¹ and R² together have a total number of carbons ranging from about 9 to about 27, and (iii) R¹ and R² are oriented as a cis isomer of the formula B.

10. The thermoplastic composition of claim 1, wherein the thermoplastic composition is a ready-for-forming formulation comprising, based on a total weight of the thermoplastic composition:
(a) non-fluorinated hydrophobic additive in an amount from about 0.2 wt. % to about 3 wt. %;
(b) synergistic polymer additive in an amount from about 0.3 wt. % to about 10 wt. %;
(c) thermoplastic polymer in an amount from about 26 wt. % to about 99.8 wt. %;
(d) optionally, secondary synergistic additive in an amount from 0 wt. % to about 1 wt. %; and
(e) optionally, other additives in an amount from 0 wt. % to about 40 wt. %;
wherein the non-fluorinated hydrophobic additive comprises fatty acid amide having a structure of: 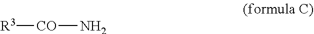
wherein R³ is a saturated and branched aliphatic hydrocarbon chain having from about 11 to about 29 carbons.

11. The thermoplastic composition of claim 1, wherein the non-fluorinated hydrophobic additive comprises primary fatty acid amide, the synergistic polymer additive comprises functional thermoplastic copolymer with pendant epoxide groups, and the non-fluorinated hydrophobic additive and the synergistic polymer additive are present at a weight ratio that corresponds to a molar ratio of about 2:1 to about 1:2.5 between moles of primary amide groups present in the non-fluorinated hydrophobic additive and moles of epoxide groups present in the synergistic polymer additive.

12. The thermoplastic composition of claim 1, wherein a specimen film formed from the thermoplastic composition has a static water contact angle of at least about 102 degrees according to ASTM D5946.

13. A thermoplastic article formed from the thermoplastic composition of claim 1, wherein the thermoplastic article is free of fluorine and fluorinated substances.

14. The thermoplastic article of claim 13, wherein the non-fluorinated hydrophobic additive is intermixed throughout the thermoplastic article.

15. The thermoplastic article of claim 13, wherein the thermoplastic article is formed from the thermoplastic composition into a useful form by one or more processes selected from extrusion, injection molding, blow molding, rotational molding, spinning, thermoplastic pultrusion, and thermoforming.

16. The thermoplastic article of claim 13, wherein the thermoplastic article is a useful form selected from fibers; films and sheets; laminates; nonwoven fabrics; pellets; and three-dimensional formed parts.

17. (canceled)

18. The thermoplastic article of claim 13, wherein the thermoplastic article has one or both of a haze of less than or equal to about 70% and a transmittance of greater than or equal to about 85%, each according to ASTM D1003 and at a specimen thickness of 0.8 mm.

19. A multilayer article comprising:
(a) an outer layer formed from the thermoplastic composition of claim 1; and
(b) an inner layer formed from a material excluding the thermoplastic composition;
wherein the multilayer article is free of fluorine and fluorinated substances

20. A system comprising:
(a) a component formed from the thermoplastic composition of claim 1, wherein the component is free of fluorine and fluorinated substances; and
(b) an aqueous liquid in physical contact with at least a portion of the component.

21. The system of claim 20, wherein the aqueous liquid comprises one or more of blood, urine, and saliva.

22. A method of imparting hydrophobicity to a surface of a thermoplastic article, the method comprising the step of forming the thermoplastic article from the thermoplastic composition of claim 1, wherein the thermoplastic article is free of fluorine and fluorinated substances.
